(19) United States
(12) Patent Application Publication
(10) Pub. No.: US 2017/0332631 A1
(43) Pub. Date: Nov. 23, 2017

(54) SYSTEM AND METHOD OF PREVENTING LICE INFESTATION

(71) Applicant: HIPROX PRODUCTS LTD., Sapir (IL)

(72) Inventors: Hod BEN YADA, Tel-Aviv (IL); Idan ALON (BEN NAIM), Sapir (IL)

(21) Appl. No.: 15/522,299

(22) PCT Filed: Oct. 27, 2015
(86) PCT No.: PCT/IL2015/051052

§ 371 Date: Apr. 27, 2017

Related U.S. Application Data
(60) Provisional application No. 62/069,349, filed on Oct. 28, 2014.

(51) Int. Cl. A01N 25/34; A45D 8/34; A45D 8/14; A01N 65/44; A01N 65/28; A01N 65/22; A01N 65/10; A01N 65/08; A01N 25/18; A45D 8/36; A01M 29/12

(52) U.S. Cl. CPC A01N 25/34; A45D 8/36; A45D 8/34; A45D 8/14; A01N 65/44; A01M 29/12; A01N 65/22; A01N 65/10; A01N 65/08; A01N 25/18; A01N 65/28

(57) ABSTRACT

A wearable device for repelling head-lice is disclosed comprising a fastener for holding the device in contact with head-hair, and a container attached to the device, the container is adapted to hold an absorbent material out of contact with the head hair. The absorbent material may be suitable to absorb a lice-repellent material, and to release the lice-repellent in the form of gas.

### BACKGROUND

Head-lice infestation is a common problem that afflicts individuals, and particularly children, world-wide. Treatments of head-lice infestations are time consuming and tedious for both the patient and the treatment provider. While preventive creams and lotions are known, there is a need for a convenient and long-lasting way to prevent head-lice infestation.

### SUMMARY

A wearable device for repelling head-lice is disclosed comprising a fastener to hold the device in contact with head-hair, and a container attached to the device, the container to hold an absorbent material out of contact with the head hair, the absorbent material suitable to absorb a lice-repellent material, and to release said lice-repellent in the form of gas. According to some embodiments the container is one of absorbent cloth and plastic adapted for out-gassing. According to further embodiments the container may have at least one hole, the hole suitable to allow the lice repellent material, when in an evaporated state, to pass out of said container. According to some additional embodiments the fastener is suitable to hold the container with said holes facing said head hair.

According to additional embodiments one of the holes is suitable to allow a drop of the liquid to pass through said holes upon an introduction of said liquid into said container, and a second of said holes is smaller than a size suitable to allow a drop of said liquid to pass through said second hole.

According to further embodiments the lice repellent material is at least one of rosemary) oil, Eucalyptus oil, tea tree oil, carrot seeds oil, Anis oil, Lavender oil, Mint oil, Carambola oil, and Citronella oil.

A method of repelling head lice according to embodiments of the invention comprising fastening a device in contact with head hair, the device including a hair fastener and a container, the container including at least one hole facing hair of a wearer when said device is fastened, introducing into the container, an absorbent material, the material kept out of contact with said hair by said container, applying to said absorbent material a lice-repelling liquid and allowing the lice repellent in an evaporated state to pass through said at least one of said holes of said container.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIGS. 1A, 1B and 1C are a bottom, side and top views of a lice prevention hair clip, where FIG. 1C shows an exploded view of a container area for holding an oil-soaked absorbent material, in accordance with an embodiment of the invention;

FIGS. 2A, 2B and 2C are a bottom, side and top view of a lice prevention hair clip that includes dimensions in accordance with an embodiment of the invention;

FIG. 3 is a schematic view of a lice prevention device as part of a head band in accordance with an embodiment of the invention; and

FIG. 4 is a schematic view of a lice prevention device as part of a hair holder in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

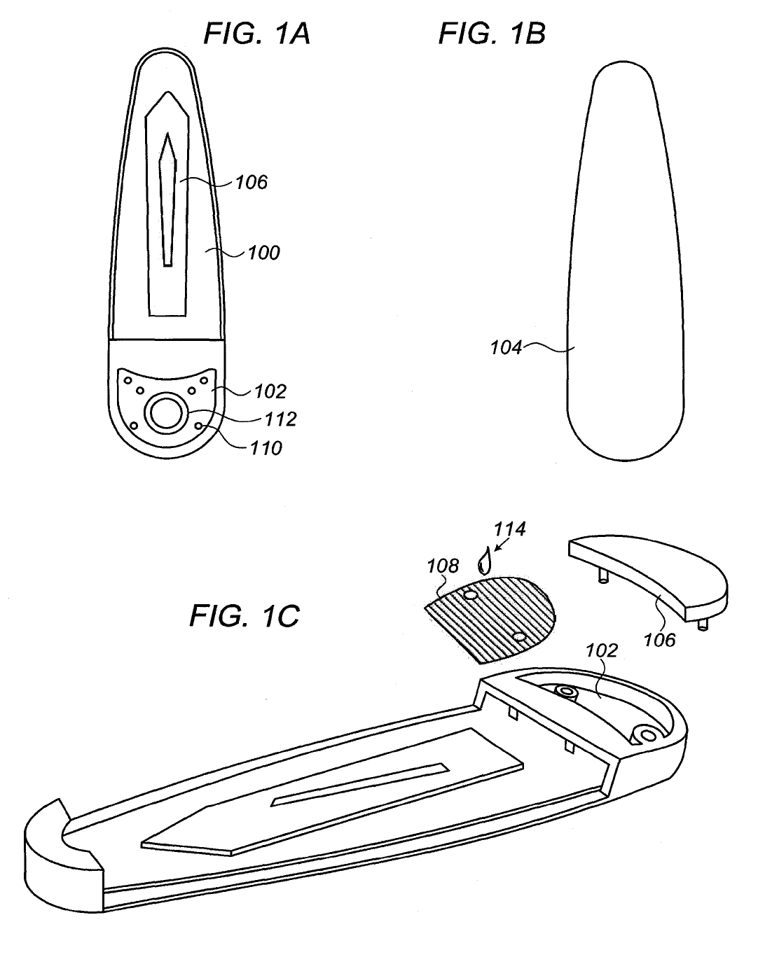

Reference is made to FIGS. 1A, 1B, showing a bottom and side views of a lice prevention hair clip respectively, and to FIG. 1C which shows an exploded view of an hair clip 100 with a container 102 for holding absorbent material capable of accommodating soaked oil or similar fluids or gels, in accordance with an embodiment of the invention. In some embodiments, a hair clip 100, hair pin or other object to hold head hair in place, or to be attached to the hair, may include a container with absorbent material, such as container 102. Such hair clip, hair pin or other hair accessories will be denoted herein after hair-related accessory. Container 102 may be built into or connected to one or more sides of the hair-related accessory, such as clip 100. Container 102 may for example be attached to, built into or otherwise made part of a hair clip 100. In some embodiments, container 102 may be or be attached to a cover 104 of hair clip 100 such as a decorative or protective cover. In some embodiments, cover 104 may enclose or cover one or more parts of the clipping mechanism 106 that may typically hold or secure hair within or to the hair clip 100.

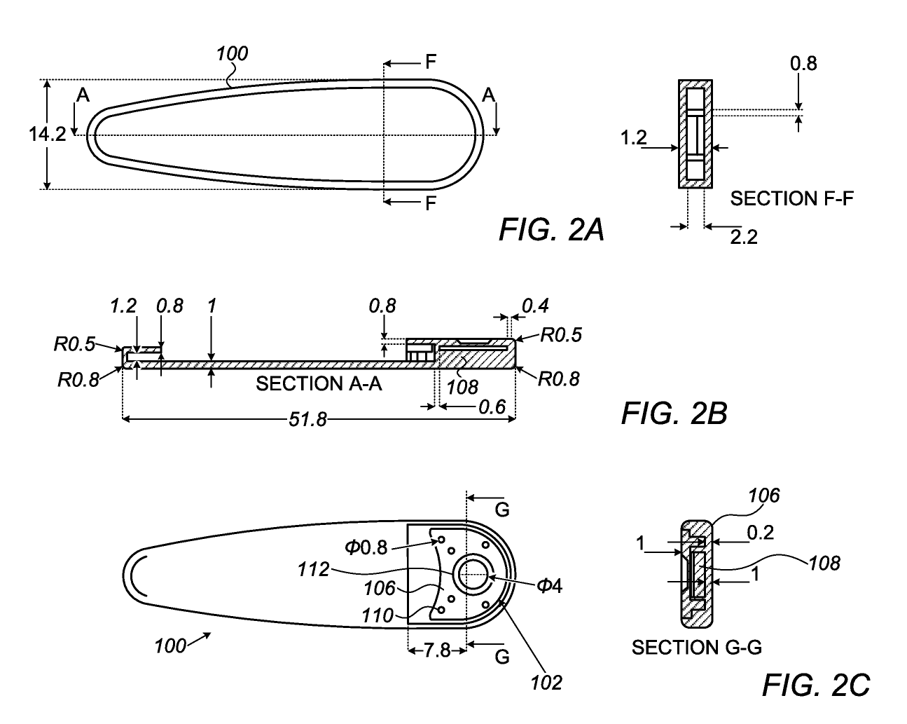

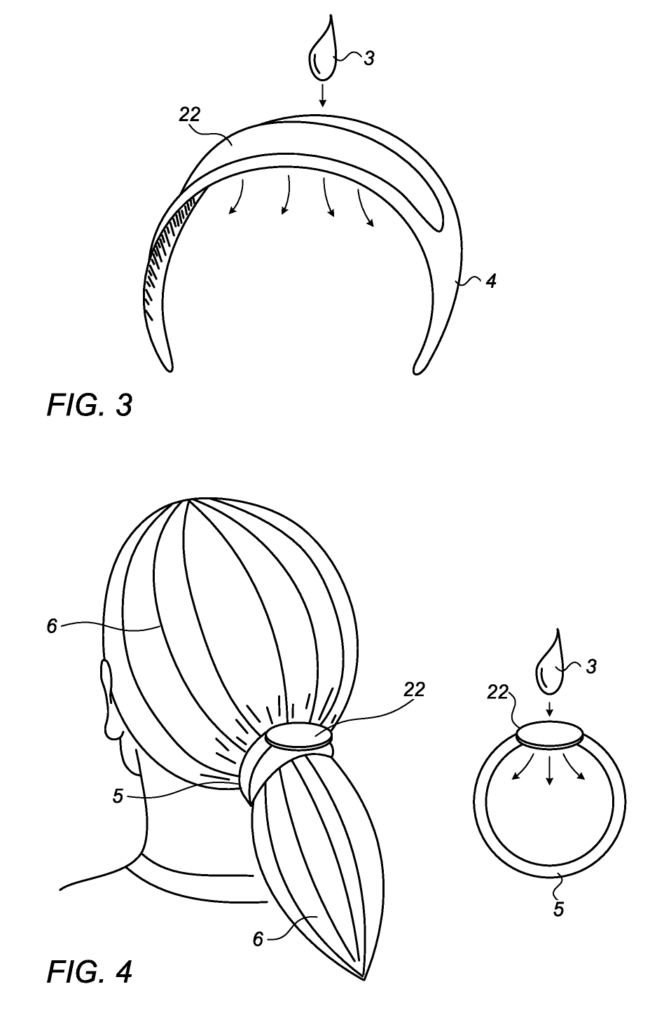

Reference is made to FIGS. 2A, 2B and 2C a bottom, side and top view of a lice prevention hair clip that includes dimensions of various parts of the hair clip in accordance with an embodiment of the invention. For example, dimensions of clip 100 may be approximately, 52 millimeters long and 14.5 mm wide. A length of clip 100 may be for example approximately 1 mm in thickness. An area of clip 100 that surrounds container 102 may have a thickness of 1.5 to 2.5 mm. Other dimensions, lengths and thicknesses may be used.

Container 102 area may include a partially or completely enclosed container that may be suitable to hold and contain a fabric or other absorbent material 108. Container 102 may be constructed of a non-water permeable material such as for example plastic or metal. A depth of an internal or vessel area of container 102 may be approximately 1 mm, and container 102 may be 7 mm in length by 8 mm in width, though other dimensions are possible. Container 102 may include a removable or fixed cover 106. A removable cover 106 may pop in and pop out upon for example the exertion of a leverage force upon for example tab in cover 106.

Cover 106 may be fashioned with one or more holes 110 through which air and other gases may freely pass. In some embodiments, cover 110 may include one or more larger holes 112 through which drops of liquid may pass, and one or more smaller holes 110 in various parts of cover 106.

Absorbent material 108, such as a fabric, sponge, fiber sheet or other absorbent material may be shaped to fit the inside dimensions of container 102. Material 108 may be packaged in stand-alone units or as cut-out or semi-perforated cut-out shapes from a sheet of material that may include several removable units. In some embodiments material 108 may include or be fashioned of felt or other synthetic fibers.

In operation, material 108 may be inserted into or included inside of container 102, and cover 106 may be closed to securely hold material 108 inside container 102. One, two, three or more drops 114 of a liquid, such as for example rosemarine (rosemary) oil, Eucalyptus oil, tea tree oil, carrot seeds oil, Anis oil, Lavender oil, Mint oil, Carambola oil, Citronella oil or other aromatic liquids that may deter, repel or be unattractive to head lice or other hair-infestation pests may be dispensed from for example a dropper through for example hole 112 or holes 110, and such liquid may moisten or soak material 108 so that the liquid is held by material 108 within container 102 and does not spill out. Clip 100 may be clipped onto a wearer's hair such that, in some embodiments, holes 110 and 112 are facing the head or hair. Evaporating or gaseous repellent may flow through holes 110 and 112, and may repel lice or other pests and prevent infestation of hair. In some embodiments, oil or liquid may be replenished on a daily or periodic basis when the oil that was absorbed in material 108 is mostly evaporated, dries out or otherwise loses is effectiveness as a repellent.

Reference is made to FIG. 3, a semi-rigid head band 4 in accordance with an embodiment of the invention. In some embodiments, a container 2 may be included in, attached to or otherwise made part of a semi-rigid head band that may be worn above or around a skull of a wearer. Container 2 may include holes (not shown) that face the skull or hair of a wearer.

Reference is made to FIG. 4, an elastic hair band or hair scrunchy 5 in accordance with and embodiment of the invention. An elastic or hair scrunchy 5 may include a container 22 to hold and enclose an absorbent material that may be provided in the form of drops 3, into which a repellent liquid may be filled or soaked, and holes in the container (not shown) may be configured to face hair 6 or surround hair 6 or a hair 6 area of a wearer, and to allow controlled slow release of the molecules of aromatic material filled in container 22.

In some embodiments a container may be included in a hat, visor, sweat band, head band, beanie, yarmulke, glasses, goggles or other devices worn in a vicinity of or adjacent to an area of the hair.

According to some embodiments the deterring or repellent material to be released as gas may be introduced into a piece of plastic based on technique known as out-gassing of volatile materials. Materials capable of out-gassing from plastics may be evaporated or released or emitted to the immediate vicinity of the hosting piece of plastic. Some materials capable of being out-gassed are organic compounds known as volatile organic compounds, or VOCs. According to this embodiment the stage of soaking an absorbent with liquid or gel, which will later be released as gas, is not required. Instead, a piece of plastic ‘loaded’ with VOC or other type of volatile material may be introduced, attached, be made part of, etc. a hair clip, a hat and the like. Accordingly, when the volatile material is one of the materials listed above, capable of deterring or repelling lice, its conversion into gas, as it is released from the hosting plastic, may act to deter or repel louse residing in the hair of the user.

Some embodiments may include a wearable device for repelling head-lice that include a fastener to hold the device in contact with head-hair, and a container attached to or part of the device, where the container holds or surrounds an absorbent material and holds the material out of contact with the hair. The absorbent material may be suitable to absorb a liquid lice-repellent that may be introduced through one or more holes in for example a cover of the container. The hole may be suitable to allow the lice repellent in an evaporated state to pass out of the container. In some embodiments, the fastener may hold the device attached to the hair so that the holes face the hair.

In some embodiments a first of hole is suitable to allow a drop of liquid to pass through it upon the introduction of the liquid into the container, and a second hole is smaller than a size suitable to allow a drop of the liquid to pass through it.

In some embodiments, the absorbent material is a fabric, such as for example a fabric of synthetic fibers. In some embodiments, the moistened material sufficiently hold the liquid lice repellent so that it does not leak out of the container, but that only the evaporated lice-repellent is released from the container.

Embodiments of the invention may include a method of repelling head lice by fastening a device in contact with head hair, where the device has a hair fastener and a container. The container has at least one hole facing hair of a wearer when the device is fastened. Embodiments may include introducing an absorbent material into the container and keeping the material out of contact with the hair. Embodiments may include applying to the absorbent material a lice-repelling liquid; and allowing the lice repellent, in an evaporated state, to pass through the holes of the container.

In some embodiments, applying the repellent to the material includes applying the lice repelling liquid to the absorbent material through at least one of the holes.

1. A wearable device for repelling head-lice, comprising:
a fastener to hold said device in contact with head-hair, and
a container attached to said device, said container to hold an absorbent material out of contact with said head hair, said absorbent material suitable to absorb a lice-repellent material, and to release said lice-repellent in the form of gas.

2. The device of claim 1 wherein said container is one of absorbent cloth and plastic adapted for out-gassing.

3. The device of claim 1, wherein said container having at least one hole, said hole suitable to allow said lice repellent material, when in an evaporated state, to pass out of said container.

4. The device as in claim 3, wherein said device to hold said fastener is suitable to hold said container with said holes facing said head hair.

5. The device as in claim 3, wherein a first of said holes is suitable to allow a drop of said liquid to pass through said holes upon an introduction of said liquid into said container, and a second of said holes is smaller than a size suitable to allow a drop of said liquid to pass through said second hole.

6. The device as in claim 1, wherein said absorbent material comprises a fabric.

7. The device as in claim 1, wherein said absorbent material comprise synthetic fibers.

8. The device as in claim 3, wherein said lice repellent material is at least one of rosemary) oil, Eucalyptus oil, tea tree oil, carrot seeds oil, Anis oil, Lavender oil, Mint oil, Carambola oil, and Citronella oil.

9. A method of repelling head lice, said method comprising:
fastening a device in contact with head hair, said device including a hair fastener and a container, said container including at least one hole facing hair of a wearer when said device is fastened;
introducing into said container, an absorbent material, said material kept out of contact with said hair by said container;
applying to said absorbent material a lice-repelling liquid; and
allowing said lice repellent in an evaporated state to pass through said at least one of said holes of said container.

10. The method as in claim 9, wherein said applying comprises applying said lice repelling liquid to said absorbent material through at least one of said holes.
